(19) United States
(12) Patent Application Publication
(10) Pub. No.: US 2007/0172311 A1
(43) Pub. Date: Jul. 26, 2007

(54) Quick-coupling/mounting system for elevator guides

(75) Inventor: Jesus Sanz Gamboa, Vera De Bidasoa (Navarra) (ES)

Correspondence Address: LUCAS & MERCANTI, LLP, 475 PARK AVENUE SOUTH, 15TH FLOOR, NEW YORK, NY, 10016, US

(73) Assignee: S.A. DE VERA (SAVERA), VERA DE BIDASOA (Navarra) (ES)

(21) Appl. No.: 10/597,032

(22) PCT Filed: Jan. 21, 2005
(86) PCT No.: PCT/ES05/00025

§ 371 Date: Jul. 7, 2006

(30) Foreign Application Priority Data
Jan. 26, 2004 (ES) P-200400162
Jan. 27, 2004 (ES) P-200400169
Oct. 29, 2004 (ES) P-200402613

(51) Int. Cl. B25G 3/00

(52) U.S. Cl. 403/252

(57) ABSTRACT

Rapid connection/assembly system, for lift guides, each guide (1) including a core-head (13) and some flanges (14) that have some machined parts (141) placed around some previously defined connection points; some connection plates (2) are organised into two plate parts (2a) that can be moved in some tightening means (2b), 21), (22) mounted on these plate parts (2a) which when brought closer together, tighten these plate parts (2a) sideways against the flange (14), and on each plate part (2a) there are alignment elements (3), (241) that centrally and in a combined way match the machined parts (141) at the connection points (P) of the flanges (14). For application in the manufacture of lift guides.

This invention deals with a rapid assembly connection system for lift guides.

Lift guides require greater and greater quality and precision coefficients each day, basically due to the users' comfort requirements. The connections between these guides must be carried out in compliance with these quality and precision requirements.

A guide connection is comprised of three basic elements:

a) the actual guides,

b) guide connection plate,

c) connecting screws of guides with the connection plate.

All the connection systems known suffer from two problems:

a) these three basic elements are presented independently in the assembly

b) the alignment of the guides and the connection plate is complicated per se and this difficulty is greater if we bear in mind that it has to be carried out in places that are difficult to access and in complicated positions.

In a traditional guide connection system, all of this results in the coupling operations of the three basic elements, their alignment and anchor/fastening, usually taking around 9 minutes.

It is understood perfectly that any improvement in the simplification of the assembly will represent a great advance in this technological field and will speed up the actual assembly without detriment of the quality and precision required.

The applicant has realised that in the known connection system, the connection plate and the guide flanges are joined vertically.

The applicant has solved these problems arranging for:

a) the connection plate to be divided into two plate parts that already have the connecting means/screws mounted

b) the flanges and the plate parts to be equipped with combined alignment configurations, so that their mutual coupling and relative alignment is carried out very quickly.

The connection plate and the guide flanges are joined together/tightened horizontally (laterally).

With the invention system, the coupling/alignment/anchor operations take 20 seconds.

More specifically, the rapid connection/assembly system for lift guides, where each guide includes a head-core on which a precision finish has been carried out on its upper reference surface (OX axis) and a precision finish on its side reference surfaces (OY axis) and one flange on each side, is characterised because:

a) at least one connection point is determined on each flange of each guide, situated at a predetermined set height with respect to the upper reference surface of the head and at a predetermined set distance with respect to its respective reference side surface of the head;

b) a machine finish open to the exterior is placed on the flanges around each connection point;

c) there are some connection plates, each one of which extends between the flanges of each side of at least two guides; this connection plate is organised into two plate parts that correspond to the flanges of each side and that can be moved on some torque means mounted on these plate parts which, when moved closer together, tighten these plate parts laterally against the flanges;

d) there are alignment elements on each plate part, which correspond centrally and combined with the machine finished at the connection points of the flanges, so that when the plate parts are tightened against the flanges, all the connection points of the flanges of each side of the guides are in a straight line.

In order to understand the subject of this invention better, a preferential form of practical execution is illustrated on the drawings, subject to incidental changes that take nothing away from its foundation.

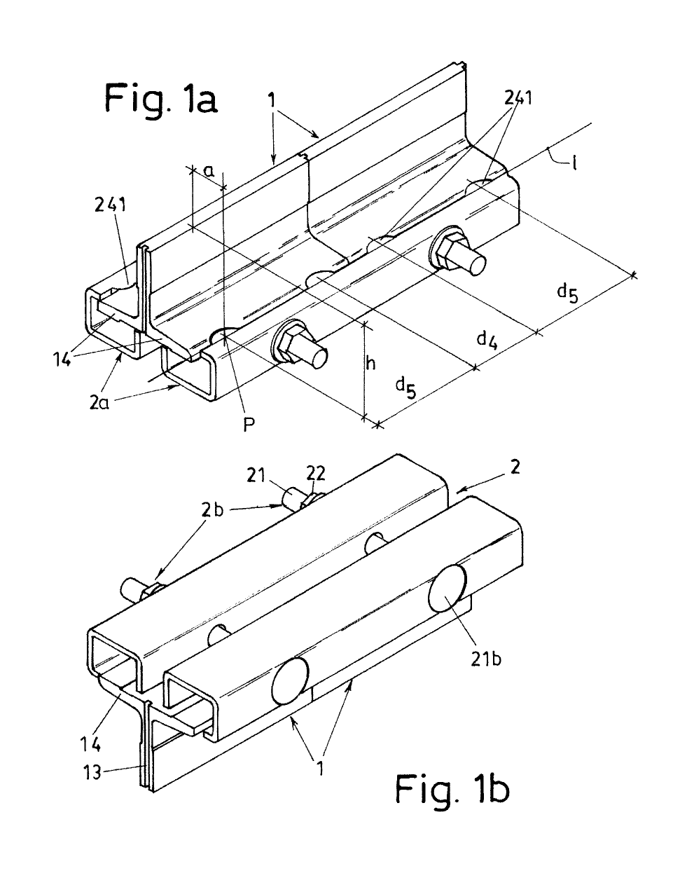

FIGS. 1a and 1b show several general views in frontal perspective—FIG. 1a—and rear perspective—FIG. 1b—of a practical execution of the system targeted by the invention.

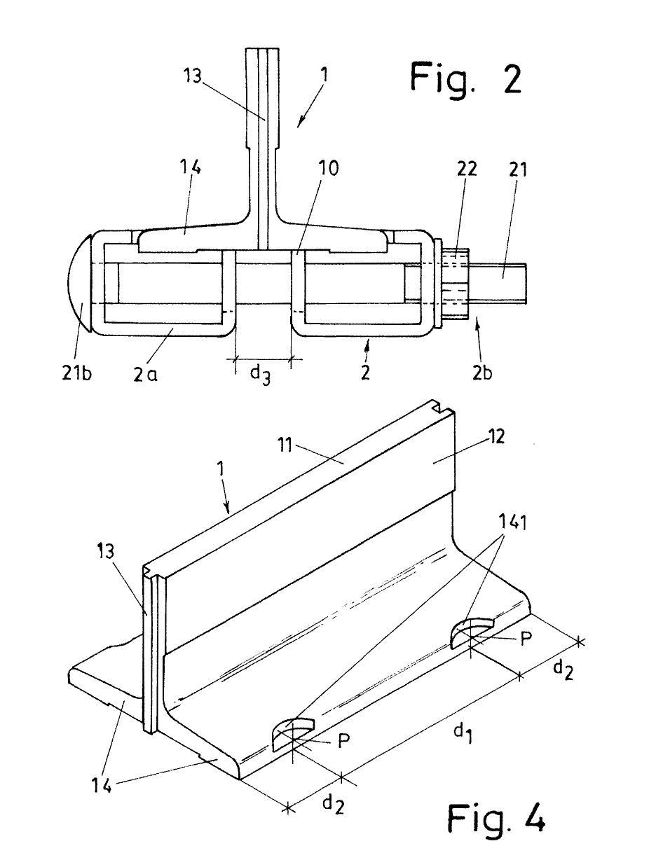

FIG. 2 shows a ground plan corresponding to the previous figure.

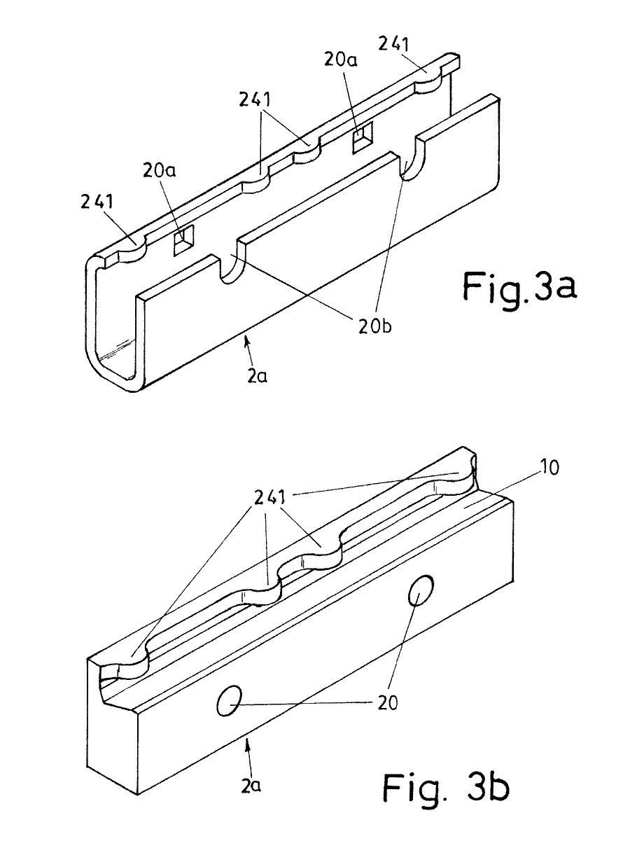

FIG. 3a shows a perspective view of a longitudinal-part (2a)) (plate part) for the execution of FIGS. 1 and 2 (“U”-shaped profile).

FIG. 3b shows a perspective view of a longitudinal-part (2a) (plate part) for the execution of FIGS. 1 and 2, for an alternative execution (solid part).

FIG. 4 shows a partial perspective view of FIGS. 1 and 2 of one guide (1), with a solution of boxes/skating (1411 (open machine finish device) machined on the flanges (14).

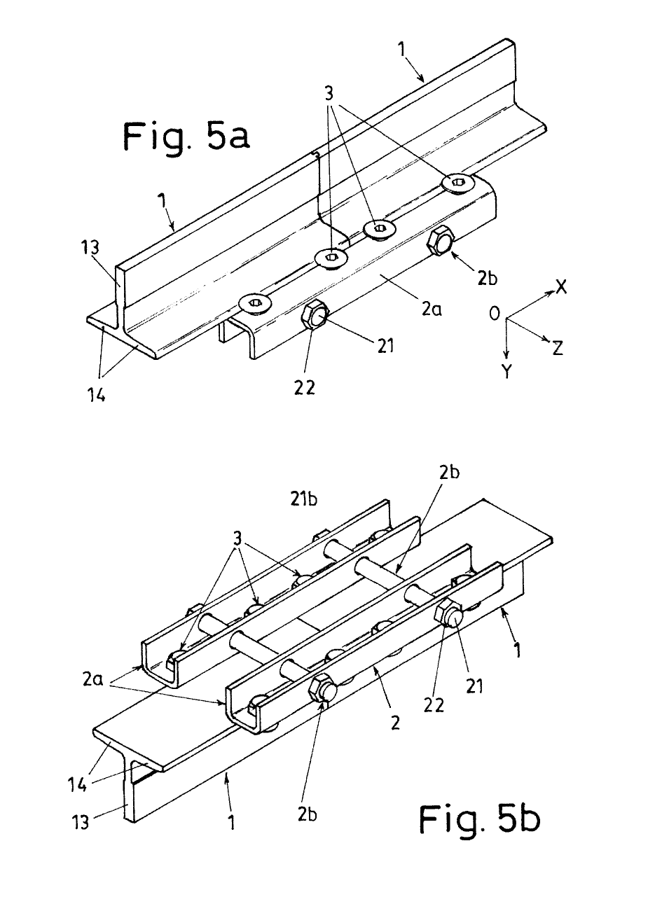

FIGS. 5a and 5b show several general front—FIG. 5a—and rear—FIG. 5b—perspective views of another practical execution of the system targeted by the invention in which the open machined parts (141) of the guides to be joined together (1) are open through boxes and the connection plate (2) is comprised of two longitudinal-parts (2a) connected to each other with the tightening means, in this case by two sets of studs (21)/nut (22).

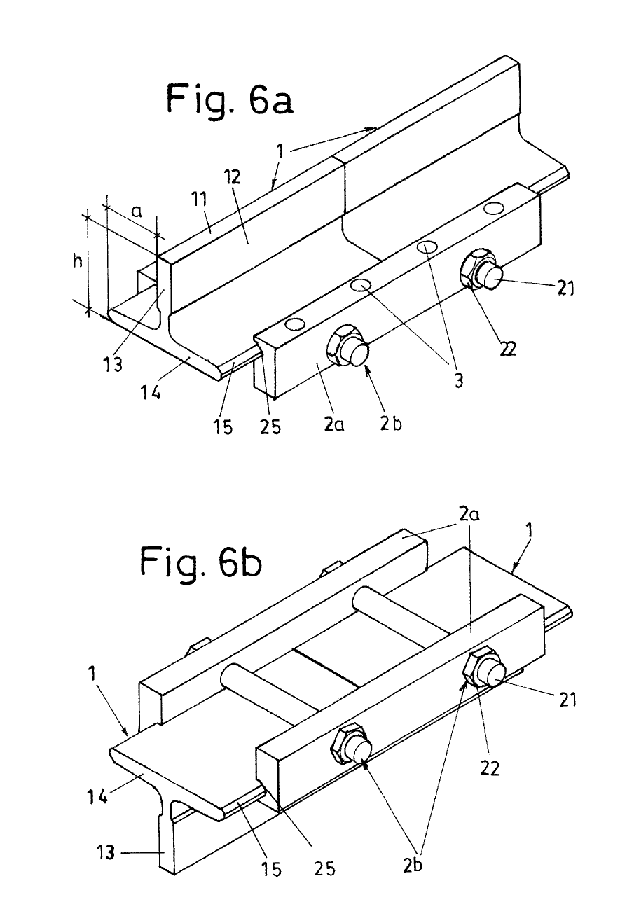

FIGS. 6a and 6b show different general perspective views, one front and one rear of another practical execution of the system targeted by the invention in which the open machined parts (hidden) of the guides to be connected (1) are spaced open boxes and are connected together by continuous chamfers (15). These chamfers (15) are double and the connection plate (2) is comprised of two solid longitudinal-parts (2a) (plate parts) connected together by two sets of stud (21)/(22) (tightening means) and with a longitudinal box (25).

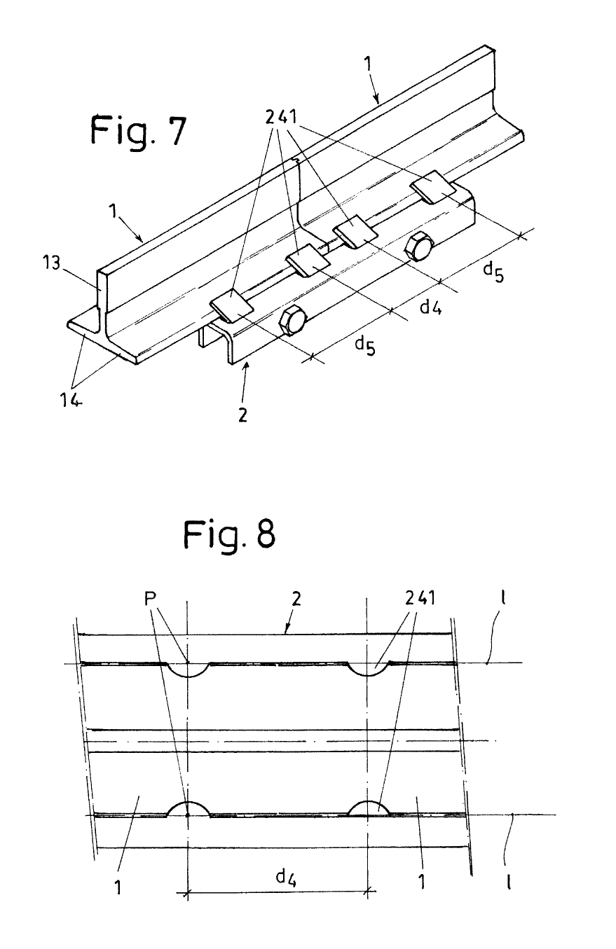

FIG. 7 shows a general front perspective view of another practical execution of the system targeted by the invention in which the machined parts (141) of the guides to be connected together (1) are open boxes and the alignment elements (214) are die-stamped flanges integrated into the longitudinal-parts (2a).

FIG. 8 is a schematic description of the connection with a minimum number of connection points (P) between each other, that is, one connection point (P) for each flange.

Below an example of a non-limitative practical execution of this invention is described.

The rapid connection/assembly system for lift guides, targeted by the invention, is used on guides (1), which include a core-head (13) and a flange (14) on each side.

According to said invention:
The core-head (13) of each guide has a precision finish on its upper surface (11)—upper surface of reference according to OX-axis—and a precision finish on its side surfaces (12)—side surfaces of reference according to OY-axis—.
Several connection points (P) are determined on each flange (14) of each guide (1), situated at a predetermined set height (h) with respect to the upper surface of reference (11) and at a predetermined set distance (a) with respect to the respective side surface of reference (12) (they form straight line I).
There is a connection plate (2) that extends between the aforementioned connection points (P) of the flanges (14) of each side of at least two guides (1) placed continuously.
There are some alignment elements (241) on the connection plate (2), combined with some open machined parts (141) at connection points (P) on the flanges (14).
Each flange (14) forms in origin some machined finishes (141); these machined devices (141) are placed in opposing pairs (one on each flange) on the connection points (P): one pair or several pairs separated from each other by a distance (d₁) the last of these pairs being machined at any distance (d₂) from the end of the guide (1).
The upper surface (11) and side surfaces (12) of the head (13) are used as reference to position the machined parts (141) in origin. Their centres coincide with the connection points (P), at a set distance (h) from the upper surface of reference (11) of the head (13) according to the OY-axis and at a set distance (a) from the side surfaces of reference (12) of the head (13) according to the OX-axis. All of this leads to a much shorter assembly time than that currently known and an automatic alignment on the OX and OY-axes by means of the machined parts open to the exterior (141) on the flanges (14).
The connection plate (2) (FIGS. 1 to 4) is organised into two plate parts (2a) (longitudinal-parts) with tightening means (2b) to bring them closer together or separate them, which, in origin form some protuberances (241) arranged into opposing pairs: at least two pairs separated from each other by a distance (d₄). These protuberances (241) form the alignment means integrated into the actual connection plate (2).

The open machined parts (141) formed on the flanges (14) of the guides (1) to be joined together are boxes that are open to the exterior—see FIG. 4—. These open machined parts (141) are separated from each other by a distance (d₁) and at a distance (d₂) from the end of the relative guide (1) to be joined.

These distances (d₁), (d₂) which, in principle, may be any, condition the distances of the connection plate (2) that are defined below.

In the execution example shown, the tightening means (2b) to bring the longitudinal-parts (2a) closer together or further apart, they are different cross-parts.

For a first variant of this execution example,—see FIG. 3a—each longitudinal-part (2a) is an elongated “U”-shaped profile with asymmetric flanges, which form conformation pairs (20) in both flanges—an anti-rotation opening (20a) and an open box (20b) that face each other in pairs—and which forms an end bend on one of them, with many protuberances (241) (alignment elements) opposing each other in pairs and centred and dimensionally combined with the boxes/skating (141) (open machined parts).

For a second variant of this execution example—see FIG. 3b—, each longitudinal-part (2a) is solid with pairs of openings (20) along its body, from which a wall extends that forms the protuberances (241).

In the execution example shown pairs of protuberances (241) have been machined in the longitudinal-parts (2a). The two inner pairs are machined at a distance (d₄) from each other and the two outer pairs are machined at a distance (d₅) from each other—see FIG. 1a—.

d₄=2d₂ and d₅=d₁ must be satisfied—see FIGS. 1a and 4—.

The tightening means (2b) are comprised of a set of stud (21)/nut (22), which is inserted into a pair of opposing conformations (20). The maximum separation amplitude (d₃) between longitudinal-parts (2a) is limited by the head (21b) of the stud (21) and by the actual nut (22) and varies depending on the width of the guides (1) to be joined together. Therefore, according to the invention, one same connection plate (2) can be applied to join pairs of guides (1) of different widths (it is understood that, in each connection, the guides (1) are equal to each other).

The retention takes place by clamping the flanges (14) of the guides (1) to be connected between this alignment elements (protuberances) (241) inserting them into the boxes/skating (open machined parts) (141) and applying the nuts (22) of the sets of stud (21)/nut (22) that form the tightening means (2b). A rotation momentum takes place when tightening that makes the guides (1) rest upon the protuberances (214) and in the skatings (10) of the longitudinal-parts (2a).

With the executions of FIGS. 5a, 5b, 6a and 6b, the alignment elements (3) are pre-mounted on the connection plate (2).

The open machined parts (141) conformed on the edges of the flanges (14) of the guides (1) to be connected are through open boxes.

In the execution example, in agreement with FIGS. 6a and 6b, the structure of the connection plate (2) comprises plate parts (2a) and tightening means (2b) in a similar way and layout to that described, with the peculiarity that the plate parts (2a) include some machined parts (25) that are V-shaped longitudinal guides and the pre-mounted alignment means (3) are spigots inserted into these longitudinal-parts (plate parts (2a) so that they interrupt the continuity of these longitudinal guides (25) at distances (d₄), (d₅) also similar to those already described.

The open machined parts (141) formed on the flanges (14) of the guides (1) to be connected are open boxes attached to each other by continuous chamfers (15), which occupy at least the length of the flanges (14) in contact with the connection plate (2). These chamfers (15) may be simple or double—as in FIGS. 6a and 6b—without altering, as a result, the essence of the invention, as it only require varying in a combined way the geometry of the “V”-shaped guides (25).

In the execution example—in agreement with FIG. 7—the open machined parts (141) on the connection points (P) formed at the edges of the flanges (14) of the guides (1) to be joined are through boxes.

Each longitudinal-part (plate part) (2a) is an elongated U-shaped profile that forms pairs of openings (20) on its flanges opposing each other in pairs and in its core many aligned die-stamped flanges (241) (alignment elements), also opposing each other in pairs.

FIG. 8 shows by way of a diagram the simplest execution, that is, a connection point (P) for each flange (14) of each guide (1) aligned on each side forming straight lines (I).

1. Rapid connection/assembly system, for lift guides, where each guide (1) includes a head-core (13) where a precision finish has been carried out on its upper surface of reference (11) (OX-axis) and a precision finish on its side surfaces of reference (12) (OY-axis) and a flange 814) on each side; characterized because:
a) at least one connection point (P) is determined on each flange (14) of each guide (1), situated at a predetermined set height/h) with respect to the upper surface of reference (11) of the head (813) and at a predetermined set distance (a) with respect to the respective side surface of reference (12) of the head (13);
b) a machine finish (141) open to the outside is placed on the flanges (14) around each connection point (P);
c) some connection plates (2) are placed, each one of which extends between the flanges (14) of each side of at least two guides (1); this connection plate (2) is organized into two plate parts (2a) which match the flanges (14) of each side and which can be moved in some tightening means (2b), (21), (22) mounted on these plate parts (2a), which, when moved closer together, tighten these plate parts (2a) laterally against the flanges (14);
d) on each plate part (2a) there are alignment elements (3), (241) which centrally and in a combined way match the machined parts (141) on the connection points (P) of the flanges), so that when the plate parts (2a) are tightened against the flanges (14) all the connection points (P) of the flanges (14) of each side of the guides (1) remain in a straight line (I).

2. Rapid connection/assembly system, for lift guides, according to previous claim, characterized because:
a) each flange (14) forms some open machined parts (141) in origin; these machined parts are placed in opposing pairs: one or several pairs spaced out at any distance (d₁) the last of these pairs being machined at any distance (d2>from the end of the guide (1);
b) the upper surface (11) and the side surfaces (12) of the head (13) are used as reference to position in origin the open machined parts (141), whose centers are the connection points (P);
c) a connection plate (2) is placed, organized into two plate parts (2a) with tightening means (2b) to bring them closer/separate them to a maximum distance (d3>, and which form some alignment elements (241) in origin, which are distributed into at least two pairs separated from each other by a distance (d₄); these alignment elements (241) form the retention means which, integrated into the actual connection plate (2) and dependent upon this, attach is securely and jointly to the flanges (14) of two guides (1) to be joined;
so that for the rapid connection/assembly, it is sufficient to place the machined parts (141) opposite each other, (241) of the guides (1) and compress longitudinal-parts (2a) of this connection plate (2) closer together.

3. Rapid connection/assembly system, for lift guides, according to claim 2, characterized because the alignment elements (241) are distributed into at least four pairs separated from each other, two by two by a distance (ds).

4. Rapid connection/assembly system, for lift guides, according to claim 2, characterized because in the relationship between distances (di), (d2>, (d4>, (ds) the following must be satisfied:
d4=2d2 y ds=di

5. Rapid connection/assembly system, for lift guides, according claim 1, characterized because each plate part (2a) is an elongated “U”-shaped profile with asymmetrical flanges, one of them bent towards the interior, and couples of conformations (20) opposite each other, to house the tightening means (2b).

6. Rapid connection/assembly system, for lift guides, according to claim 5, characterized because these alignment elements (241), which form the integrated retaining means and dependent on the base plate (2) are protuberances that are dimensionally combined with the open machined parts (141) and forming the bend of one of the asymmetric flanges of these plate parts (2a).

7. Rapid connection/assembly system, for lift guides, according to claim 1, characterized because the aforementioned tightening means (2b) are sets of stud (21) and nut (22), housed in opposing conformation sets (20) on the plate parts (2a) so that the maximum separation distance (d3>between plate parts (2a) is delimited, respectively, by the nut (22) and the head (21b) of the stud (21).

8. Rapid connection/assembly system, for lift guides, according to claim 5, characterized because these conformations (20) are, in each set, an anti-rotation opening (20a) and an open box (20b).

9. Rapid connection/assembly system, for lift guides, according to claim 1, characterized because the plate parts (2a) are solid, with an extension wall on whose end the alignment elements (241) are placed forming a bend.

10. Rapid connection/assembly system, for lift guides, according to claim 9, characterized because these conformations (20) are through openings.

11. Rapid connection/assembly system, for lift guides, according to claim 1, characterized because:
a) each flange (14) forms some machined parts (141) in origin; these machined parts are placed in opposing pairs: one or several pairs are separated between each other by any distance (di) the last of these pairs being machined at any distance (d2>from the end of the guide (1);
b) the upper surface (11) and side surfaces (12) of the head (13) are used as reference to position the open machined parts (141) in origin, whose centers are the connection points (P);
c) there is a connection plate (2) organized into two plate parts (2a) with tightening means (2b) bring them closer together/further apart, to a maximum distance (d3>;
d) there are alignment elements (3) pre-mounted on these plate parts (2a) that can be moved closer; so that for the rapid connection/assembly it is sufficient to position the open machined parts (141) of the guides (1) opposite the alignment elements (3) pre-mounted on the connection plate (2), then compressing the plate parts (2a) of this connection plate (2) when moved closer to.

12. Rapid connection/assembly system, for lift guides, according to claim 11, characterized because the plate parts (2a) are solid and the alignment elements (3) are spigots inserted into these plate parts (2a) so that they interrupt the continuity of some longitudinal guides (25) that cover some continuous chamfers (15) that attach to each other the open machined parts (141) of the guides (1) to be connected.

13. Rapid connection/assembly system, for lift guides, according to claim 1, characterized because these alignment elements (241) are die-stamped flanges in the core of these plate parts (2a).

14. Rapid connection/assembly system, for lift guides, according to claim 13, characterized because these die-stamped flanges (241) are conformed in the core of the plate parts (2a).
